(19) United States
(12) Patent Application Publication
(10) Pub. No.: US 2019/0137939 A1
(43) Pub. Date: May 9, 2019

(54) Smart Timer Device

(71) Applicant: Ha X. Nguyen, Algonquin, IL (US)

(72) Inventor: Ha X. Nguyen, Algonquin, IL (US)

(21) Appl. No.: 16/184,978

(22) Filed: Nov. 8, 2018

Related U.S. Application Data
(60) Provisional application No. 62/582,953, filed on Nov. 8, 2017.

(51) Int. Cl. G04F 3/06; G06Q 10/10; G04G 21/04

(52) U.S. Cl. CPC G04F 3/06; G04G 21/04; G06Q 10/1091

(57) ABSTRACT

A smart timer device and associated methods are disclosed. The smart timer having at least a receiver and a visual indicator. The receiver configured to wait for a message, receive the message, process the message, and obtain a value from the message. The visual indicator connected in association to the receiver and displaying the visual indicator for a set amount of time based on the value obtained from the message.

### RELATED APPLICATIONS

This application claims the benefit of provisional application 62/582,953 filed 8 Nov. 2017.

### FIELD OF THE INVENTION

The present invention generally relates to a timer device. More particularly, this invention disclosed herein relates to the field of timing devices that are used for managing employees' job performance and work hours.

### BACKGROUND

In small business owners often focus more on marketing and sales, relying mostly on their employees performing services for clients. More specifically, in beauty (nail, hair, etc.) and massage businesses, most employees are independent contractors. Frequently this means that the independent contractors will compete among themselves for clients. Further, they can exploit most modern systems to get to the next clients in line by skipping procedural steps to shorten working time to complete the requested services.

In the beauty and massage business, many services are pricing based on time of performance. For example, $30 can be priced for 30 minutes of massage. Currently, beauty salons use manual timers; these timers do not work, particularly when there are clients waiting in line. Employees ignore the timers and/or set the time to only 25 minutes, instead of 30 required. These behaviors cause many internal issues, customer dissatisfaction, and reduced quality. In addition, proprietors can face ethical and moral dilemmas as well as the possibility for legal action.

Further, workstations at the beauty and massage salons are sometimes equipped with electronic devices for clients—not for employees. Those owners of the business have no choice, having to use manual timers for managing their employees performing services. Tasks or services in the context of beauty and massage business include, for example, pedicures, manicures, acrylic nail sets, massages

Other inventions and attempts have been made to solve this problem, a survey of which are presented below.

US PGPUB 2002/0145559 by Sullivan disclosed a time and location keeper for employees includes a device which includes a power supply, a smart GPS receiver, and a data transmitter such as a cell phone. The components are worn on the person, for example in a compartmented belt. Time and location data are sent to a base station from the transmitter, which may be activated automatically on a schedule, or by a query signal from the base station.

U.S. Pat. No. 5,204,663 by Lee disclosed an access control system, and a method of controlling an access to a controlled area, comprising an integrated-circuit card key having contact pads and a sufficient memory capacity to store key access information and transaction information, information in the integrated circuit integral therein at respective addresses, and an acceptor which includes a memory to store lock access information, and circuitry for reading the key and lock access information, whenever the contact pads of the key is electrically engaged with the acceptor, comparing the key and lock access information, providing a control signal to the opening mechanism of an access controlled area based on a comparison, result and recording transactional information from the lock into the integrated circuit of the key at respective addresses.

U.S. Pat. No. 6,415,284 by D'Souza et al. disclosed fields of smart forms include default logic and verification logic to simplify filling in of the smart form by an employee and reduce the likelihood that errors in data entry occur. In particular, the default logic determines a default value for a field in the form according to one or more data items in a comprehensive company database. Verification logic verifies that the employee has entered valid form data in a particular field. The verification logic can include references to data items stored in the comprehensive company database such that data entered by the employee can be verified with respect to data already stored in the database. Data entered by the employee is stored in the database and can be used by default logic and/or verification logic in subsequently used smart forms.

U.S. Pat. No. 6,581,025 by Lehman disclosed a time and work tracker that automatically collects and analyzes information about time and work performed on a wireless device is described herein. According to the present invention, a time and work tracking function is initiated on a wireless device. Thereafter, a user begins to perform work on the wireless device. As the user works, the tracking function on the wireless device collects data relating to the activities performed by the user. The collected data is then analyzed to determine what types of work the user has actually performed.

Accordingly, there is a market for this present invention of a smart timer device consisting of a system, a computer-implemented method, and a computer application capable of providing managing employees' service performance. This will reduce unnecessarily tension at workplace, improve quality of lives, and importantly growing business. These features, and others, of the Smart Timer Device are disclosed herein and discussed in greater detail below.

### BRIEF SUMMARY

Currently-available devices, as discussed above, therefore currently do not use a novel system as described herein. This design is both interesting and easily usable, two important features in the modern timekeeping market.

To resolve the workplace conflicts as mentioned above, the present disclosure contemplates a system, a computer-implemented method, and a computer application for making a smart timer device managing employees performing services.

A system, a computer-implemented method, and a computer application in the present invention provide for presenting visual indication for a period of time required by a service. According to the present disclosure, a smart timer device ensures an employee stays on his/her job until the device's indicator is turned off by the device. For example, a client contracts for a massage for 45 minutes: an employee starts performing the service, and at the same time, a smart timer device turns an indicator (a LED) on. The indicator stays on for 45 minutes and the employee then must perform the service for the client until the LED is turned off by the device—not by the employee. The visual indicator of the LED ensure the client's satisfaction that he/she has received what they have paid for.

In one implementation, the present disclosure of a smart timer device provides a method of presenting visual indication for a period of time required by a service to a service performer, including receiving a service message with a value of time via a WIFI network, turning an indicator (LEDs) on for a period of time required by a service, turning the indicator(s) off as the time elapsed.

In an aspect of the present disclosure, a smart timer device is a computer, including, but not limited to, a processor, memory, user interface, indicators, input/output interface, communication network, universal serial bus, memory card interface, power supply. The indicators include, but are not limited to, LEDs, displays, and touch screens. The communication network includes, but not is not limited to, WIFI, Bluetooth, ethernet, and cellular networks. The memory cards include, but are not limited to, SD cards, ROM, and RAM. The user interface includes, but is not limited to, switches, touch screens, and sensors. The power supply includes, but is not limited to, AC-DC power adapter, and batteries.

In a first embodiment [RESERVED FOR FINAL DRAFT]

In a second embodiment [RESERVED FOR FINAL DRAFT]

In another embodiment [RESERVED FOR FINAL DRAFT]

Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1a is a front view of the smart timer device as described by the present disclosure in a first state.

FIG. 1b is a front view of the smart timer device of FIG. 1a in a second state.

FIG. 2 is a block diagram showing the operation of a smart timer device according to the present disclosure in connection with a network.

FIG. 3 is a block diagram showing an exemplary computing structure according to the present disclosure.

FIG. 4 is a flowchart and method for use with a smart timer device described by the present disclosure, showing the smart timer device as a server.

FIG. 5 is a schematic diagram for operation of an exemplary application according to the present disclosure.

FIG. 6 is a block diagram displaying exemplary messages and communications for use with a smart timer device according to the present disclosure.

FIG. 7 is a flowchart and method for use with a smart timer device described by the present disclosure, showing the smart timer device configured to be a client.

FIG. 8 is a flowchart and method for use with a smart timer device described by the present disclosure, showing the smart timer device as a client.

FIG. 9 is a block diagram displaying exemplary client configured messages and communications for use with a smart timer device according to the present disclosure.

### DETAILED DESCRIPTION

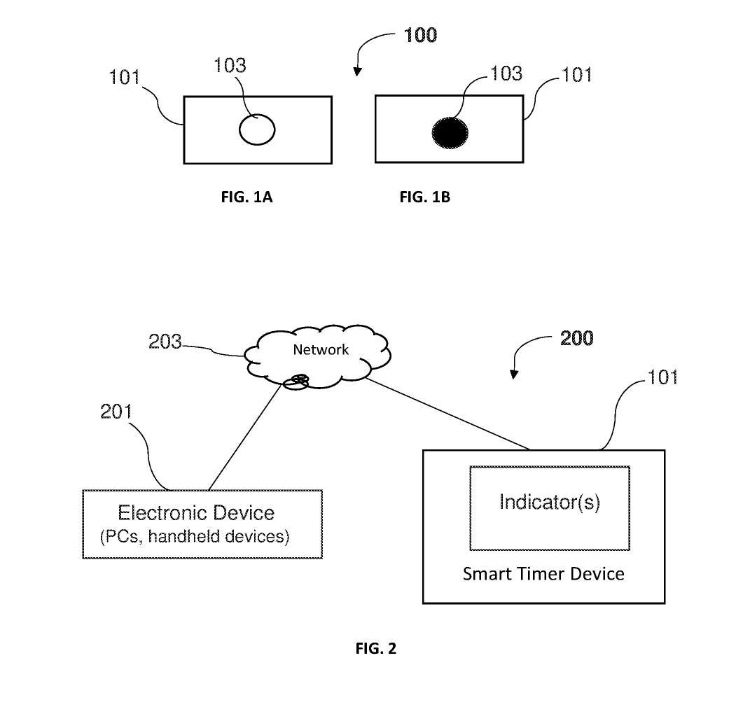

Referring now the drawings with more specificity, the present invention essentially provides for a smart timer device. The preferred embodiments of the present invention will now be described with reference to FIGS. 1-9 of the drawings. Variations and embodiments contained herein will become apparent in light of the following descriptions.

Looking now to FIG. 1a smart timer device 101 according to the present disclosure is shown in a first state. In FIG. 1a smart timer device 101 is waiting for a service message (e.g. 601) from a client electronic device (e.g. 201). Indicator 103 in this state is off and not illuminating. In a preferred embodiment indicator 103 is an LED, although other indicators are contemplated herein.

In a second state, smart timer device 101 is shown in FIG. 1b. In this state service message (e.g. 601) from a client electronic device (e.g. 201) was received by the smart timer device 101. The message's value is embedded in the service message 501 before it is sent to the smart timer device 101. Accordingly, a smart timer device 101 will turn on the indicator 103 on for a prescribed amount of time (e.g. 30 minutes, 45 minutes, etc). The combination of FIGS. 1a and 1b combine to form smart timer device system 100.

In FIG. 2 a smart timer device 101 is shown in exemplary system 200. System 200 includes smart timer device 101, electronic device 201 and network 203. In an exemplary embodiment, device 201 is connected to smart timer device 101 via a web socket connection.

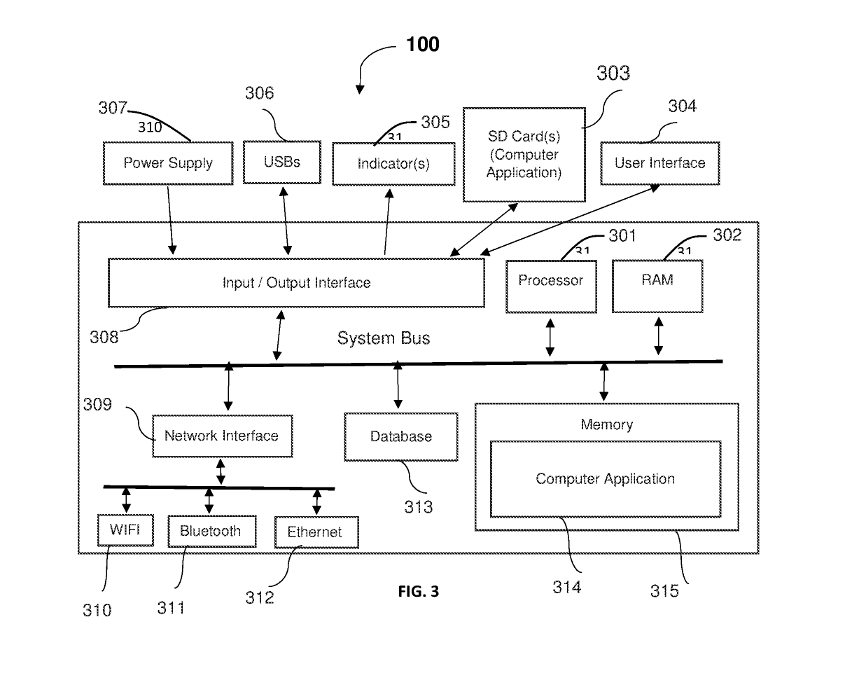

Looking now to FIG. 3 system 100 can be seen in greater detail. Smart timer device 101 is seen to include a processor 301, RAM 302, ROM (memory) 315, removable memory component SD card(s) 303, user interface 304, indicators 305, universal serial buses (USBs) 306, power supply 307, I/O Interface 308, Network interface 309, WiFi 310, Bluetooth® 311, Ethernet 312, database 313, and computer application 314. Additional circuitry may be contemplated for various embodiments. In this exemplary configuration I/O interface 308 connects power supply 307, USBs 306, indicators 305, SD cards 303, and user interface 304 to the system bus. Network interface 309 connects wifi 310, bluetooth 311 and Ethernet 312 to the system bus. ROM 315 generally contains application 314, and is directly connected to the system bus, as are processor 301, RAM 302, and database 313.

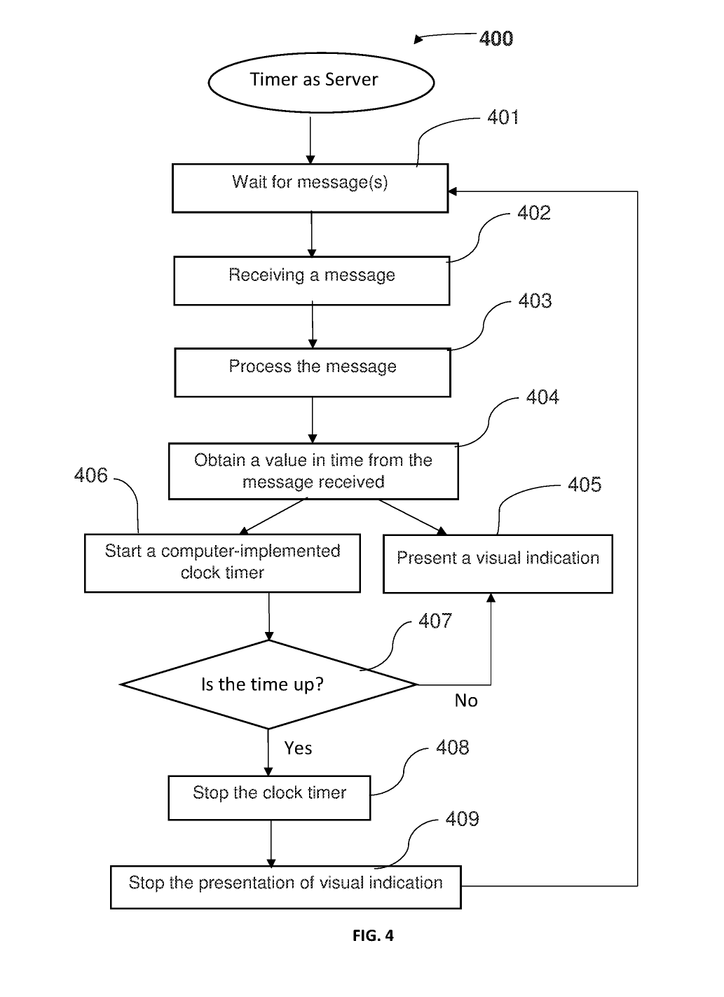

Method 400 for managing an employees' performance using smart device 101 is shown in FIG. 4. In particular, smart timer device 101 is turned on by the method including indicator 103 (LED) for a period of time required by service message 601 which is received. The method contemplates waiting 401 for a service message 601 which is received from client electronic device 201. When the message is received 402, a message module 503 processes 403 the message 601. Value 603 for service 602 (embedded in message 601) is then obtained 404 by the method. After time value 603 is obtained 404, module 501 begins presenting a visual indication 405 (using LED 103) and simultaneously starts a computer-implemented clock timer 406 based on time 603. The method then continually asks whether the time is up 407 and if not maintains visual indicator 405. If time is up the clock timer is stopped 408, the visual indication is stopped 409, and the device returns to the state of waiting for messages 401.

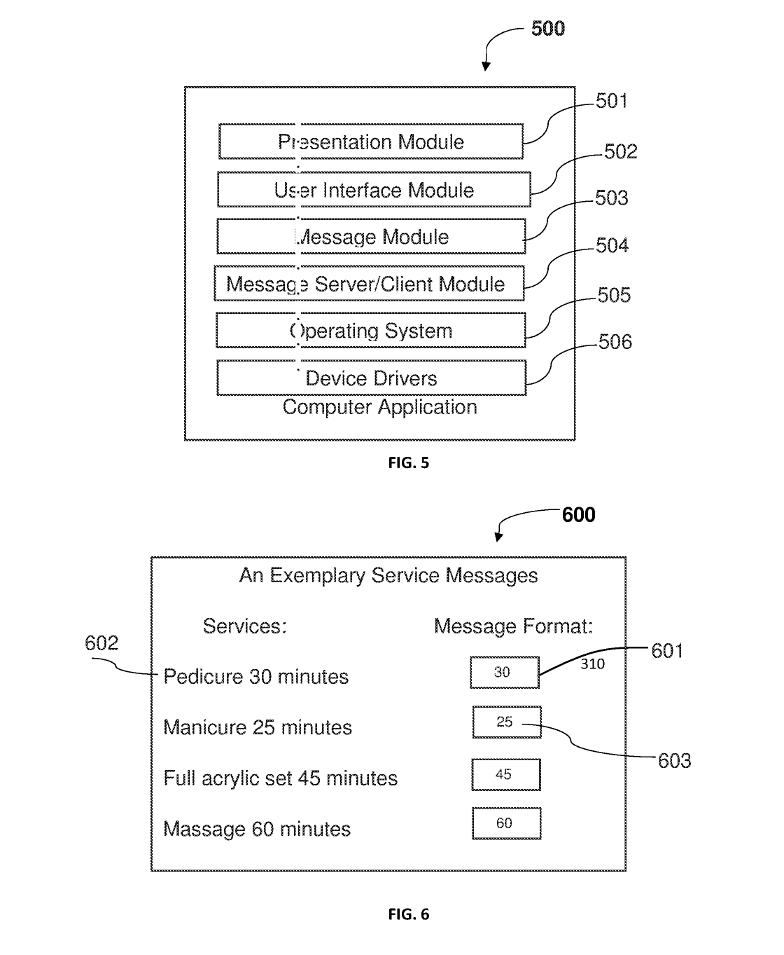

Computer application 500 is shown in greater detail in FIG. 5. In at least one embodiment, application 500 resides in micro SD card 303. Computer application 500 includes a presentation module 501, user interface module 502, message module 503, message server/client module 504, operating system 505 (in some embodiments linux or android are used), and device drivers 506. Device drivers 506 are used for functions such as network interface, I/O, user interface, and others.

FIG. 6 shows an array 600 of exemplary service messages. These messages can be displayed by timing device 101 on indicator 103 in certain embodiments, typically this would be shown if indicator is an LED display or micro touch screen. Display of these is controlled by application 500. Service message 601 includes a time 603 and a service 602 and is communicated through network 203 before being processed and/or displayed.

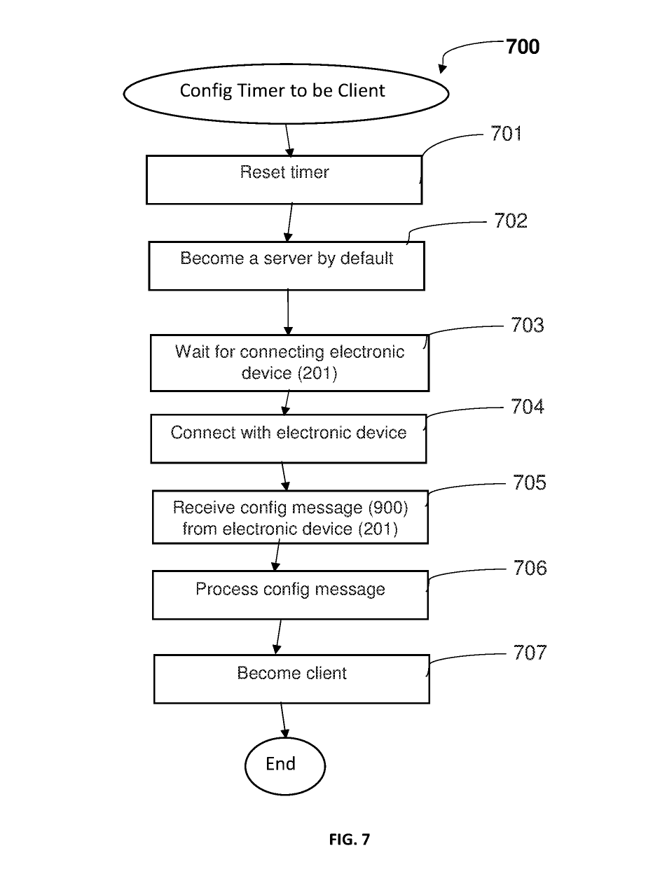

Method 700 for configuring a smart timer device 101 is shown in FIG. 7. In particular, smart timer device 101 is configured by the method as desired by user. The method contemplates resetting 701 smart timer device 101 by pressing a button or by setting command from electronic device 201. Upon reset, smart timer device becomes a server by default 702. As a server, it waits 703 for client device 201 wanted to communicate to it. If connecting 704 successfully, it receives 705 configured message 900 from the electronic device 201. After configured message 900 is obtained 705, module 504 begins processing 706 the configured data. The method then stores in memory the SSID (router name) 901, router password 903, remote server port number 905 and remote server IP address 907. Now the smart timer device 101 is a client.

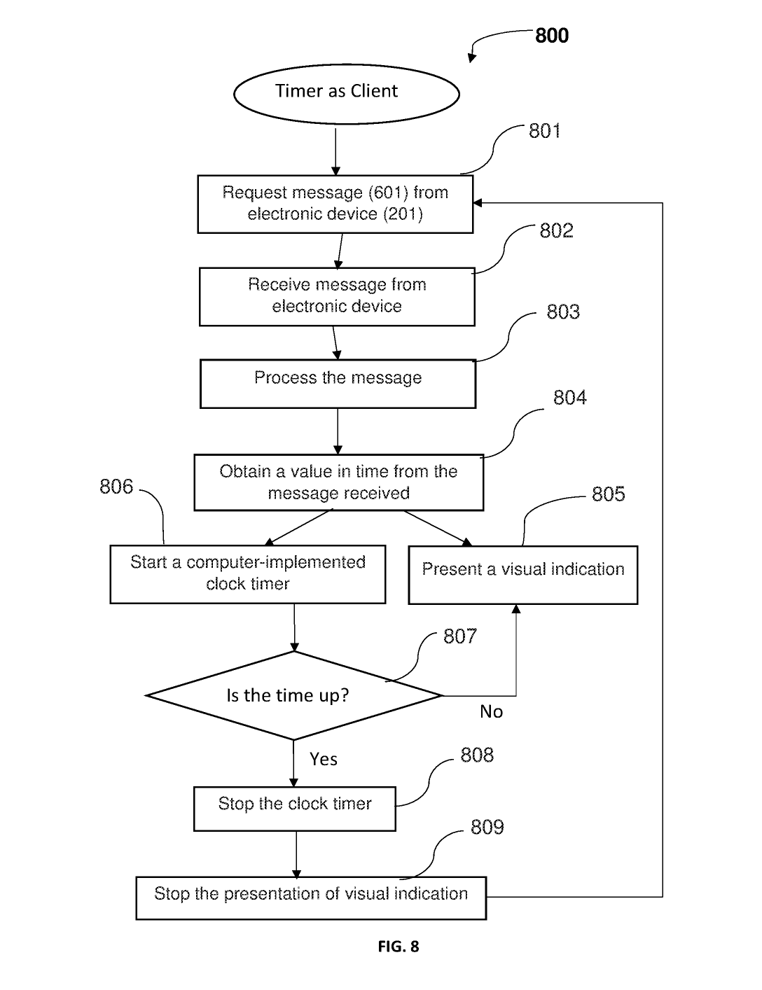

Method 800 for managing an employees' performance using smart device 101 is shown in FIG. 8. In particular, smart timer device 101 is turned on by the method 800 including indicator 103 (LED) for a period of time required by service message 601 which is received. The method 800 contemplates requesting 801 for a service message 601 which is received from electronic device 201. When the message is received 802, a message module 503 processes 803 the message 601. Value 603 for service 602 (embedded in message 601) is then obtained 804 by the method. After time value 603 is obtained 804, module 501 begins presenting a visual indication 805 (using LED 103) and simultaneously starts a computer-implemented clock timer 806 based on time 603. The method then continually asks whether the time is up 807 and if not maintains visual indicator 805. If time is up the clock timer is stopped 808, the visual indication is stopped 809, and the device returns to the state of requesting 801 for messages.

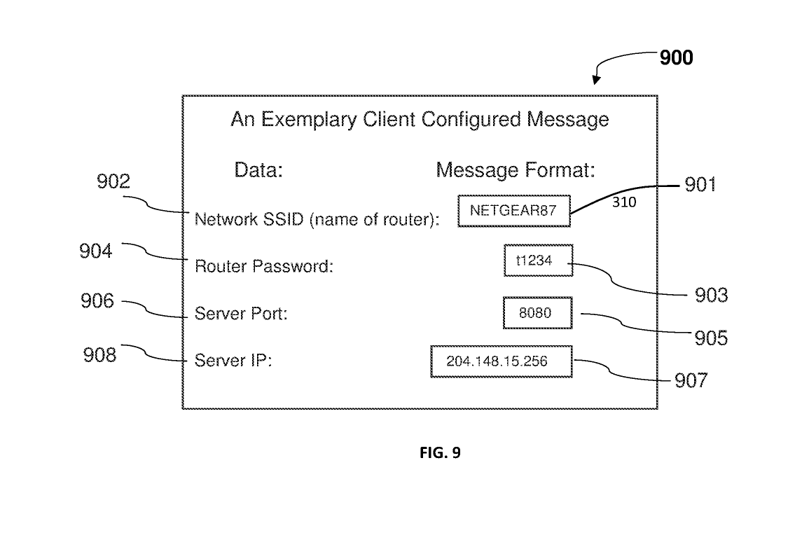

FIG. 9 shows an array 900 of exemplary client configured message. The message contains required data to configure smart timer device 101 to be a client. The client 101 communicating to a remote server 201 needs to know the server's network data 900: Network SSID 901, SSID Name 902, Router password 903, password display 904, remote server port number 905, server port indicator 906, remote server IP address 90 and server ip indicator 9087. This config data is processed by application 500 and is communicated through network 203.

### INDUSTRIAL APPLICABILITY AND CONSTRUCTION

In an aspect of the present disclosure, a smart timer device 101 is a computer 100, including, but not limited to, a processor 301, memory 314, user interface, indicators 305, input/output interface 308, communication network, universal serial bus 306, memory card interface, power supply 307.

The indicators 103 include, but are not limited to, LEDs, displays, and touch screens.

The communication network 309 includes, but not is not limited to, WIFI, Bluetooth, Ethernet, and cellular networks.

The memory cards include, but are not limited to, SD cards 303, ROM, and RAM. The user interface includes, but is not limited to, switches, touch screens, and sensors.

The power supply includes, but is not limited to, AC-DC power adapter, and batteries.

In some aspects of the invention, the smart timer device 101 of the present invention is embedded in a housing making out of wood, plastic, or metal.

In some embodiments of the invention, the smart timer device 101 of the present invention is mounted on the surface of a SPA pedicure chair. In this configuration, the smart timer device 101 of the present invention can be embedded onto the surface of a SPA pedicure chair in the view of technicians performing services.

In an embodiment of the invention, the smart timer device 101 of the present invention is mounted on the surface of a worktable.

In some embodiments of the invention, a smart timer device 101 of the present invention is embedded onto the surface of a worktable in the view of technicians performing services.

In another embodiment of the invention, a smart timer device 101 includes a processor 301 programmed to execute computer application 314 containing programming instructions. The instructions perform a computer-implemented method 400 for managing employees performing services. In a further aspect of the invention, the computer-implemented method 400 disclosed herein provides for managing employees performing services, consisting of waiting for service messages, receiving service messages, processing service messages, obtaining required execution time of services, displaying indicators, stopping displaying indicators as services' required execution time elapsed.

In an embodiment of the invention, if users want to have the present invention's system with a touch screen, the system is implemented on a mobile phone device. In some embodiments, visual indication presented includes images, icons, clips, and other implementations known in the art.

In certain embodiments of the invention, an exemplary service message 600 includes, at least a value in time 603 (hour, minute, second, or millisecond. Further, an exemplary service message includes at least a value in time (hour, minute, second, or millisecond) combined with text characters 602. Further in some embodiments, an exemplary service message is packed (embedded) in a pre-defined format. A smart timer device 101 of the present invention will processes it and behaves accordingly.

In an embodiment of the invention, the smart timer device 101 is a server for transmitting and receiving pre-defined messages via a communication network. An electronic device with network capability (Client Electronic Device 201), such as mobile phone, can connect and send pre-defined messages to the present invention of a smart timer device. More particularly, a server implements TCP/IP sockets for communication.

In an embodiment of the invention, the smart timer device 101 of the present invention is used to control more than one indicators and/or user interfaces, and/or in combination of indicators and user interfaces.

In an embodiment of the invention, a client electronic device 201 can be mounted on a workstation or at a workstation's area for service performers able to see it.

In another embodiment of the invention, computer application 314 is written in computer programming languages such as, but not limited to, C, C++, Java, C#, Linux, Unix, JavaScript, Html, sketch (Ardunio). And operating system includes, but not limited to, ubuntu, Linux, Red Hat, vustom real time operating system (RTOS). Processor includes, but not limit to, PowerPC, Intel, AMD, Texas Instruments, ARM, Espressif.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. A smart timer device comprising:
a transceiver, the transceiver configured to wait for a message, receive the message, process the message, obtain a value from the message, and to send a second outgoing message; and
a visual indicator, the visual indicator connected in association to the receiver and displaying the visual indicator for a set amount of time based on the value obtained from the message.

2. The smart timer device of claim 1 wherein:
the transceiver receives the message from an electronic device; and
the transceiver sends the message to the electronic device.

3. The smart timer device of claim 2 wherein:
the message passes through a communication network the network being at least one remote computer.

4. The smart timer device of claim 1 further comprising:
a processor with memory connected to the transceiver and visual indicator;
a computer application having an operating system, device drivers, programming;
wherein the visual indicator is a user interface and a display device; and
wherein the transceiver is a communication network interface.

5. The smart timer device of claim 4 wherein the device is implemented on a smart handheld device.

6. The smart timer device of claim 4 wherein the smart timer device is mounted;
the mount location selected from the group consisting of: a surface of a workstation, the back of a chair, and a place in view of a personnel who perform a service.

7. A method for timing services comprising:
starting a device;
waiting for a client and user inputs or requesting data from server;
receiving a message containing a time value;
processing the message;
obtaining the time value from processing the message;
presenting a visual indicator that a time value has been obtained;
starting a clock timer with a set time based on the time value;
determining whether the clock timer has timed out;
changing the visual indicator when the clock timer has timed out.

8. The method of claim 7 wherein:
the message also contains text that indicates client services requested.

9. The method of claim 7 wherein:
the message is received via a communication network from a connected remote computer.

10. The method of claim 9 wherein:
the visual indicator is an LED.

11. The method of claim 9 wherein:
the visual indicator is an electronic visual display that displays the set time, the clock timer, and an indication of client services requested.

12. The method of claim 11 wherein:
receiving the message includes receiving a message from a client electronic device.

13. The method of claim 12 wherein:
receiving the message includes a confirmation of assignment of service for client services requested.

14. The method of claim 11 wherein:
the electronic visual display is a touchscreen.

15. A method for reporting data comprising:
starting a device;
obtaining data from a user and adjusting the device's status;
transmitting data to a remote computer via a communication network;
receiving response from the remote computer;
processing the response; and
storing data from a remote computer.

16. The method of claim 15 further comprising:
resetting the device;
the device becoming a server by default after it is reset;
waiting for a client and user inputs;
connecting with the client;
receiving configured data from the client;
processing the configured data;
storing the configured data in memory; and
wherein the becomes a client.
